(19) United States
(12) Patent Application Publication
(10) Pub. No.: US 2009/0268592 A1
(43) Pub. Date: Oct. 29, 2009

(54) Information recording medium, recording apparatus and recording method

(75) Inventor: Kazuo Kuroda, Saitama (JP)

Correspondence Address: YOUNG & THOMPSON, 209 Madison Street, Suite 500, ALEXANDRIA, VA, 22314, US

(73) Assignee: Pioneer Corporation, Tokyo (JP)

(21) Appl. No.: 11/922,205

(22) PCT Filed: Jun. 16, 2006
(86) PCT No.: PCT/JP2006/312140

§ 371 Date: Apr. 7, 2008

(30) Foreign Application Priority Data
Jun. 16, 2005 (JP) 2005-176192

(51) Int. Cl. G11B 7/24

(52) U.S. Cl. 369/275.3; G9B/7

(57) ABSTRACT

A pre-recording region (13) and a post-recording region (14) are formed on a recording disk (1). In the pre-recording region (13), reproduction sequence control data (21) is unrewritably recorded. In the post-recording region (14), a reproduction data unit can be additionally written. The post-recording region (14) is divided into a plurality of unit regions (24). The reproduction sequence control data (21) is made to have a control data unit (23) corresponding with the unit region (24) by 1:1 relationship. The control data unit (23) is made to have information defining the recording position and the length of the corresponding unit region (24).

### TECHNICAL FIELD

The present invention relates to an information recording medium, such as a DVD, and a recording apparatus for and a recording method of recording information onto such an information recording medium.

### BACKGROUND ART

Currently, write-once type/rewritable type information recording media, such as a DVD-R (DVD Recordable) and a DVD-RW (DVD ReWritable), are spread. By using the write-once type/rewritable type information recording media, a user can record video images the user personally takes onto the information recording medium as motion picture data, or the user can record pictures the user personally takes onto the information recording medium as still image data. Alternatively, the user can record music the user personally selects onto the information recording medium as audio data.

For example, the user can make an original DVD photo album by recording the pictures the user personally takes onto a DVD-R as the still image data.

### DISCLOSURE OF INVENTION

### Subject to be Solved by the Invention

In general, however, in order to that the data recorded on the information recording medium can be reproduced on various players which comply with the standard of the information recording medium, authoring is necessary. If, for example, the still image data is recorded onto the DVD-R on the basis of the DVD video format to make the DVD photo album, it is insufficient for the user to merely record the still image data onto the DVD-R. The user has to establish a DVD title by authoring after recording the still image data.

The authoring operation is not always easy because it takes a lot of trouble with the setting of a data reproduction order or the like.

In view of the above-exemplified problems, it is therefore a first object of the present invention to provide an information recording medium, a recording apparatus, a recording method, and a computer program, which can omit the trouble in authoring.

It is a second object of the present invention to provide an information recording medium, a recording apparatus, a recording method, and a computer program, which can simplify the self-production of a multimedia work by the consumer public and the production of a multimedia work by a producing agent service company.

### Means for Solving the Subject

The above object of the present invention can be achieved by an information recording medium provided with: a pre-recording area in which reproduction order control data is recorded in advance; and a post-recording area for recording a reproduction data unit, wherein the reproduction data unit can be additionally recorded into the post-recording area, the post-recording area is partitioned into a plurality of unit areas, each of which has a predetermined length and which are physically continuously arranged, before the reproduction data unit is recorded into the post-recording area, the reproduction order control data is data for controlling a reproduction order of the reproduction data unit recorded in each of the unit areas, and the reproduction order control data has position information, which indicates a position of each of the unit areas, before the reproduction data unit is recorded into the post-recording area.

The above object of the present invention can be also achieved by a recording apparatus for recording a reproduction data unit onto an information recording medium provided with: (a) a pre-recording area in which reproduction order control data is recorded in advance; and a post-recording area for recording a reproduction data unit, wherein (b) the reproduction data unit can be additionally recorded into the post-recording area, (c) the post-recording area is partitioned into a plurality of unit areas, each of which has a predetermined length and which are physically continuously arranged, (d) the reproduction order control data is data for controlling a reproduction order of the reproduction data unit recorded in each of the unit areas, (e) the reproduction order control data has a plurality of first control data units, (f) each of the plurality of first control data units corresponds to respective one of the plurality of unit areas, and (g) each of the plurality of first control data units has first position information, which indicates positions of the plurality of unit areas, or a jump order, which orders to jump to the plurality of unit areas, the recording apparatus provided with: a recognizing device for recognizing the number of unit areas necessary to record the reproduction data unit and a second control data unit; a position information generating device for generating second position information, which indicates a recording position of the first control data unit corresponding to the unit area next to a continuous area, which is formed of the number of unit areas recognized by the recognizing device, or its immediately preceding position; a first recording device for recording the reproduction data unit into the continuous area; and a second recording device for including the second position information into the second control data unit and recording the second control data unit, which includes the second position information, into the continuous area.

The above object of the present invention can be also achieved by a recording method of recording a reproduction data unit onto an information recording medium provided with: (a) a pre-recording area in which reproduction order control data is recorded in advance; and a post-recording area for recording a reproduction data unit, wherein (b) the reproduction data unit can be additionally recorded into the post-recording area, (c) the post-recording area is partitioned into a plurality of unit areas, each of which has a predetermined length and which are physically continuously arranged, (d) the reproduction order control data is data for controlling a reproduction order of the reproduction data unit recorded in each of the unit areas, (e) the reproduction order control data has a plurality of first control data units, (f) each of the plurality of first control data units corresponds to respective one of the plurality of unit areas, and (g) each of the plurality of first control data units has first position information, which indicates positions of the plurality of unit areas, or a jump order, which orders to jump to the plurality of unit areas, the recording method provided with: a recognizing process of recognizing the number of unit areas necessary to record the reproduction data unit and a second control data unit; a position information generating process of generating second position information, which indicates a recording position of the first control data unit corresponding to the unit area next to a continuous area, which is formed of the number of unit areas recognized in the recognizing process, or its immediately preceding position; a first recording process of recording the reproduction data unit into the continuous area; and a second recording process of including the second position information into the second control data unit and recording the second control data unit, which includes the second position information, into the continuous area.

The above object of the present invention can be also achieved by a computer program making a computer function as the recording apparatus of the present invention (including its various aspects).

The above object of the present invention can be also achieved by a computer program product in a computer-readable medium for tangibly embodying a program of instructions executable by a computer, the computer program product making the computer function as the aforementioned recording apparatus of the present invention (including its various aspects).

According to the computer program product of the present invention, the aforementioned recording apparatus of the present invention can be embodied relatively readily, by loading the computer program product from a recording medium for storing the computer program product, such as a ROM, a CD-ROM, a DVD-ROM, a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as the aforementioned recording apparatus of the present invention.

These effects and other advantages of the present invention will become more apparent from the following embodiments.

### BRIEF DESCRIPTION OF DRAWINGS

FIG. 1 is an explanatory diagram showing a first layer recording disc in a first embodiment of the information recording medium of the present invention.

FIG. 2 is an explanatory diagram showing reproduction order control data recorded in a pre-recording area of the recording disc and unit areas in a post-recording area.

FIG. 3 is an explanatory diagram showing the content of a control data unit.

FIG. 4 is an explanatory diagram showing one example of the content of total control data.

FIG. 5 is an explanatory diagram showing another example of the content of the total control data.

FIG. 6 is an explanatory diagram showing a first reproduction procedure of a reproduction data unit recorded on the recording disc of the present invention.

FIG. 7 is an explanatory diagram showing a second reproduction procedure of the reproduction data unit recorded on the recording disc of the present invention.

FIG. 8 is an explanatory diagram showing a third reproduction procedure of the reproduction data unit recorded on the recording disc of the present invention.

FIG. 9 is an explanatory diagram showing an example in which a data structure on the recording disc of the present invention is established by using the DVD video standard.

FIG. 10 is an explanatory diagram showing an example in which recording medium recognition information of the present invention is formed by using land pre-pits.

FIG. 11 is an explanatory diagram showing an example in which data structure information is recorded onto the recording disc.

FIG. 12 is an explanatory diagram showing a structural example of the reproduction data unit.

FIG. 13 is an explanatory diagram showing another structural example of the reproduction data unit.

FIG. 14 is an explanatory diagram showing a structural example of the reproduction data unit.

FIG. 15 is an explanatory diagram showing a dual-layer recording disc in a second embodiment of the information recording medium of the present invention.

FIG. 16 is an explanatory diagram showing reproduction order control data recorded in a pre-recording area of the recording disc and unit areas in a post-recording area.

FIG. 17 is an explanatory diagram showing the second embodiment of the recording disc of the present invention which employs a parallel track path method.

FIG. 18 is an explanatory diagram showing the second embodiment of the recording disc of the present invention which employs an opposite track path method.

FIG. 19 is a block diagram showing a recording/reproducing apparatus in an embodiment of the recording apparatus of the present invention.

FIG. 20 is a flowchart showing the operation of the recording apparatus of the present invention.

FIG. 21 is a flowchart showing the content of the recording process of the recording apparatus of the present invention.

### DESCRIPTION OF REFERENCE CODES

1, 3 recording disc
13, 96 pre-recording area
14, 93 post-recording area
12, 92 file system area
21, 101 reproduction order control data
23, 103 control data unit
24, 104 unit area
31 position information
32 length information
41, 42, 44 reproduction data unit
43, 45 back control data unit
61 recording medium identification information
200 recording/reproducing apparatus
206 control device

### BEST MODE FOR CARRYING OUT THE INVENTION

Hereinafter, the best mode for carrying out the invention will be explained in each embodiment in order, with reference to the drawings.

### (Physical Structure of Disc)

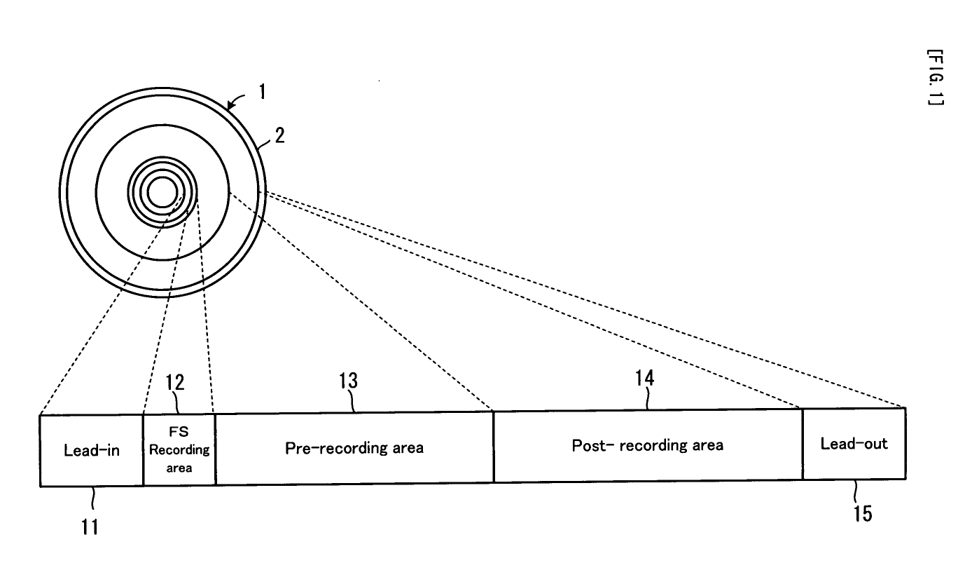

FIG. 1 shows a first layer recording disc in a first embodiment of the information recording medium of the present invention.

A recording disc 1 in FIG. 1 has a single recording layer. The recording disc 1 is a hybrid recording disc (or hybrid disc) provided with a read-only recording layer and a recordable (or write-once) recording layer. For example, the recording disc 1 is a hybrid DVD provided with the recording layer of a DVD-ROM (DVD-Read Only Memory) and the recording layer of a DVD-R.

For example, as shown in FIG. 1, out of the recording layer of the recording disc 1, a portion corresponding to a file system (FS) recording area 12, i.e. a portion located on the inner circumferential side of a disc substrate 2, is the recordable recording layer. Moreover, out of the recording layer of the recording disc 1, a portion corresponding to a pre-recording area 13, i.e. a portion located substantially in the middle portion of the disc substrate 2, is the read-only recording layer. Moreover, out of the recording layer of the recording disc 1, a portion corresponding to a post-recording area 14, i.e. a portion located on the outer circumferential side of the disc substrate 2, is the recordable recording layer. Incidentally, an area corresponding to a lead-in area 11, i.e. a portion located on the innermost circumferential side of the disc substrate 2, is the read-only recording layer. Moreover, an area corresponding to a lead-out area 15, i.e. a portion located on the outermost circumferential side of the disc substrate 2, is also the read-only recording layer.

In the recording disc 1, the read-only recording layer is a physically read-only recording layer. In this recording layer, embossed pits are formed in advance by using a stampa or the like. With respect to this recording layer, it is impossible to write once or rewrite the data. This recording layer may have the same structure as that of the recording layer used for a general DVD-ROM.

In contrast, in the recording disc 1, the recordable recording layer is a physically recordable recording layer. In this recording layer, embossed pits are formed in advance by using a stampa or the like. With respect to this recording layer, it is possible to record the data as pits by using heat deformation of an organic dye film or a change in refractive index of the organic dye film by heat. However, the once recorded data cannot be rewritten. This recording layer may have the same structure as that of the recording layer used for a general DVD-R.

Incidentally, the location on the recording layer of the pre-recording area 13 and the location on the recording layer of the post-recording area 14 may not be those shown in FIG. 1. However, the post-recording area 14 is desirably physically continuous on the recording layer. Moreover, the pre-recording area 13 is desirably disposed to be read earlier than the post-recording area 14. By disposing pre-recording area 13 to be read earlier than the post-recording area 14, it is possible to reduce the jump of a head in a reading process, to thereby improve a reading speed.

Moreover, the information recording medium of the present invention may be an information recording medium provided substantially with: an area in which the read-only data is recorded in advance; and an area in which the data can be written once (or additionally recorded) or can be rewritten. Therefore, in the information recording medium of the present invention, it is unnecessary to set the recording layer corresponding to the area in which the read-only data is recorded in advance, as the physical read-only recording layer. For example, this recording layer may be set as a physically recordable recording layer or a physically rewritable recording layer, and the data recorded in advance in this recording layer may be made not-rewritable by an information processing method.

Moreover, the recordable recording layer of the recording disc 1 shown in FIG. 1 may be changed to a rewritable recording layer. The rewritable recording layer can be formed of a phase change film, for example. In this recording layer, the data can be recorded as pits by using a phase change. The once recorded data can be also rewritten.

### (Area Structure on Disc)

As shown in FIG. 1, in the recording layer of the recording disc 1, there are formed the lead-in area 11, the file system recording area 12, the pre-recording area 13, and the post-recording area 14, from the inner circumferential side to the outer circumferential side of the disc substrate 2.

The file system recording area 12 is an area for recording a file system. As described above, the file system recording area 12 is formed on the recordable recording layer. In the shipping from a factory of the recording disc 1, the file system is not recorded in the file system recording area 12, and the file system recording area 12 is unrecorded. The file system is recorded after the recording of a reproduction data unit is completed. The recording of the reproduction data unit and the recording of the file system will be described later.

Incidentally, in the shipping from a factory of the recording disc 1, the file system can be recorded in advance in the file system recording area 12. In this case, however, if the recording disc 1 is inserted into a reproducing apparatus in such a state that the reproduction data unit is not recorded in the post-recording area 14, the reproducing apparatus sometimes accesses the post-recording area 14 in the unrecorded state. Therefore, it is preferable not to record the file system in the file system recording area 12 in the shipping from a factory of the recording disc 1. However, it is possible to prevent the reproducing apparatus from accessing the post-recording area 14 in the unrecorded state if employing such construction that the reproducing apparatus recognizes, from recording medium recognition information descried later, the facts that reproduction order control data is recorded in advance in the pre-recording area 13 on the recording disc 1 and that the reproduction data unit can be written once into the post-recording area 14 on the recording disc 1. Therefore, if such construction is employed, the file system may be recorded in advance in the file system recording area 12 in the shipping from a factory of the recording disc 1. If employing such construction that the file system is recorded in advance in the file system recording area 12 in the shipping from a factory of the recording disc 1, the recording layer corresponding to the file system recording area 12 can be set as the physically read-only recording layer. By this, the entire continuous area from the lead-in area 11 to the pre-recording area 13 of the recording disc 1 can be set as the physically read-only recording layer. This makes it easy to manufacture the recording disc 1 and this can realize a reduction in cost of manufacturing.

In the pre-recording area 13, the reproduction order control data is recorded in advance. As described above, the pre-recording area 13 is formed on the read-only recording layer. In the pre-recording area 13, embossed pits corresponding to the reproduction order control data are formed in advance by using a stampa or the like. For example, the reproduction order control data is recorded in the manufacturing process of the recording disc 1. Therefore, in the shipping from a factory of the recording disc 1, the reproduction order control data is already recorded in the pre-recording area 13. The reproduction order control data can be neither deleted nor rewritten. Incidentally, the content of the reproduction order control data will be described later.

The post-recording area 14 is an area for recording the reproduction data unit. The post-recording area 14 is desirably one physically continuous area. Incidentally, the post-recording area 14 can be divided into several physically continuous areas; however, the more finely the post-recording area 14 is divided, the lower the substantial recording capacity of the reproduction data unit, i.e. the use efficiency of the post-recording area, becomes. By setting the post-recording area 14 as one physically continuous area, the use efficiency of the post-recording area is increased, and it is possible to increase the substantial recording capacity of the reproduction data unit.

Moreover, by setting the post-recording area 14 as one or several physically continuous areas, it is possible to record the reproduction data units with various lengths. This effect will be further described later.

In the post-recording area 14, the reproduction data unit can be additionally recorded, i.e. written once. As described above, the post-recording area 14 is formed on the recordable recording area. In the shipping from a factory of the recording disc 1, the reproduction data unit is not recorded in the post-recording area 14, and for example, the post-recording area 14 is unrecorded. The reproduction data unit is recorded by the consumer public who purchases the recording disc 1 with a recording apparatus or the like.

### (Data Structure)

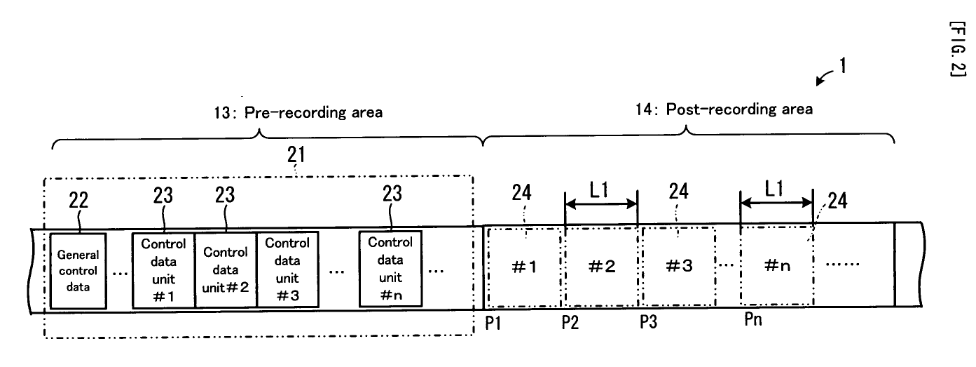

FIG. 2 shows the reproduction order control data recorded in the pre-recording area 13 of the recording disc 1 and unit areas in the post-recording area 14.

As shown in FIG. 2, the post-recording area 14 is partitioned into a plurality of unit areas 24. As described later, as a general rule, one reproduction data unit is written once into one unit area 24.

Incidentally, although the post-recording area 14 is partitioned into a plurality of unit areas 24, a physical partition does not exist in the post-recording area 14, and pre-pits which play a role of partition are not formed, and marking information which indicates a boundary between the unit areas is not recorded in the post-recording area 14. The plurality of unit areas 24 are virtually defined in the post-recording area 14 by control data units 23 of the reproduction order control data 21. However, a partition structure, such as pre-pits, may be formed in the post-recording area 14, or partition information, such as the marking information, may be recorded to partition the post-recording area 14 into the plurality of unit areas.

Each unit area 24 has a predetermined length L1, and the unit areas 24 are physically continuously arranged. The lengths L1 of the unit areas 24 are desirably all constant and equal. The length L1 of each unit area 24 is desirably greater than the length of one ECC block. Moreover, the length L1 of each unit area 24 is more desirably long enough to record about one I picture based on a MPEG standard.

The reproduction data unit is, for example, still image data, motion picture data, audio data, and the like. The reproduction data unit may be one still image data, a combination of a plurality of still image data, or mixed data of the motion picture data and the audio data. However, the reproduction data unit is desirably closed on its own. That is, it is desirable that there is no jump from the reproduction data to another reproduction data unit from the beginning to the completion of the reproduction of one reproduction data unit.

On the other hand, the reproduction order control data 21 recorded in advance in the pre-recording area 13 is data for controlling the reproduction order of the reproduction data unit recorded in each unit area 24. The reproduction order control data 21 includes general control data 22 and the plurality of control data units 23.

The control data unit 23 and the unit area 24 correspond to each other. For example, the control data unit 23 and the unit area 24 have a one-to-one correspondence relationship, and the number of the control data units 23 is equal to the number of the unit areas 24. The control data units 23 are desirably arranged physically continuously in a predetermined area in the pre-recording area 13. Moreover, the lengths of the control data units 23 are desirably equal to each other.

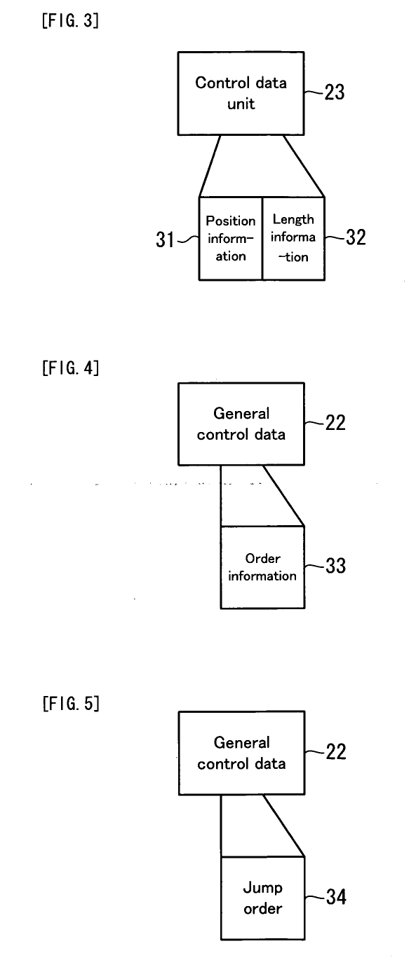

FIG. 3 shows the content of the control data unit 23. As shown in FIG. 3, the control data unit 23 includes position information 31 and length information 32. The position information 31 indicates the position of the unit area 24 corresponding to the control data unit 23. Specifically, the position information 31 is desirably a head address number of the unit area 24 corresponding to the control data unit 23. For example, as shown in FIG. 2, a control data unit #1 includes an address head number P1 of a unit area #1. A control data unit #2 includes an address head number P2 of a unit area #2. A control data unit #n includes an address head number Pn of a unit area #n.

The length information 32 shown in FIG. 3 indicates the length L1 of the unit area 24 corresponding to the control data unit 23. The control data unit 23 virtually defines the unit area 24 in the post-recording area 14 by using the position information 31 and the length information 32.

The control data unit 23 can be realized by a navigation pack based on the DVD video standard, for example.

FIG. 4 shows the general control data 22. As shown in FIG. 4, the general control data 22 includes order information 33. The order information 33 is information for defining the order to access the unit area 24. That is, the order information 33 is information for defining the order to read or reproduce the reproduction data unit recorded in the unit area 24 after the reproduction data unit is recorded into the unit area 24.

For example, it is possible to use information which describes the reading order of the control data unit 23, as the order information 33. Since the control data unit 23 includes the position information 31 and the length information 32 about the unit area 24, if the reading order of the control data unit 23 is determined, it is possible to determine the access order of the unit area 24 and the reproduction order of the reproduction data unit recorded in the unit area 24.

The general control data 22 can be realized by VTSI (Video Title Set Information) based on the DVD video standard, for example. Moreover, the order information 33 can be realized by a PCB (Program Control Block) based on the DVD video standard, for example.

Incidentally, if the recording order of the control data unit 23 matches a data reading direction by the reproducing apparatus (e.g. a direction from the inner circumferential side to the outer circumferential side of the recording disc 1) and if it is ensured that the data reading direction by the reproducing apparatus is always maintained, the order information 33 may be eliminated.

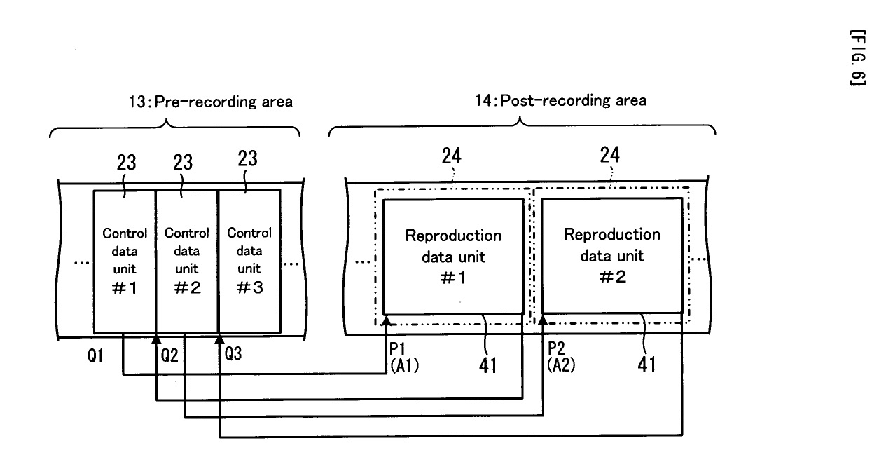

Moreover, as shown in FIG. 5, instead of or in addition to the order information 33, a jump order 34 may be included in the general control data 22. For example, an order to jump from the control data unit 23 to the corresponding unit area 24, a jump order to jump from the unit area 24 to the control data unit 23 corresponding to the next unit area 24, and a jump order to jump between the control data units 23 may be included in the general control data 22. Moreover, by combining the jump orders, the reading order of the general data unit 23, the access order of the unit area 24, or the reproduction order of the reproduction data unit may be determined.

### (Recording of Reproduction Data Unit)

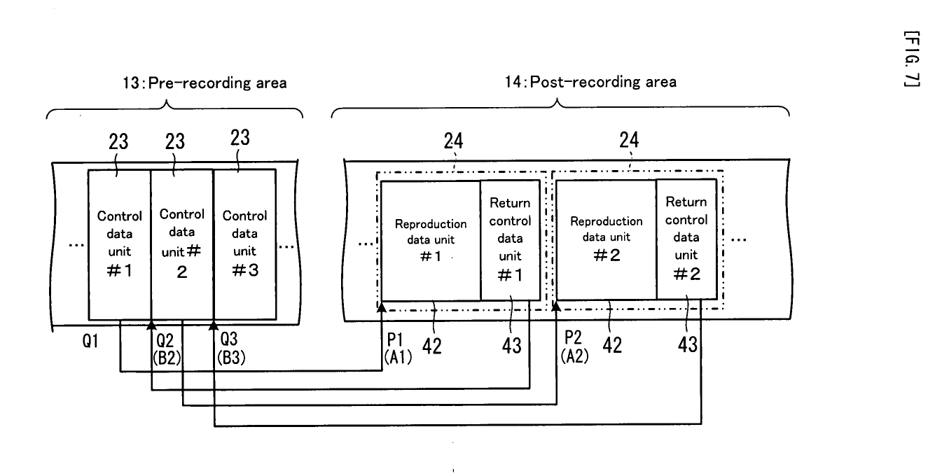

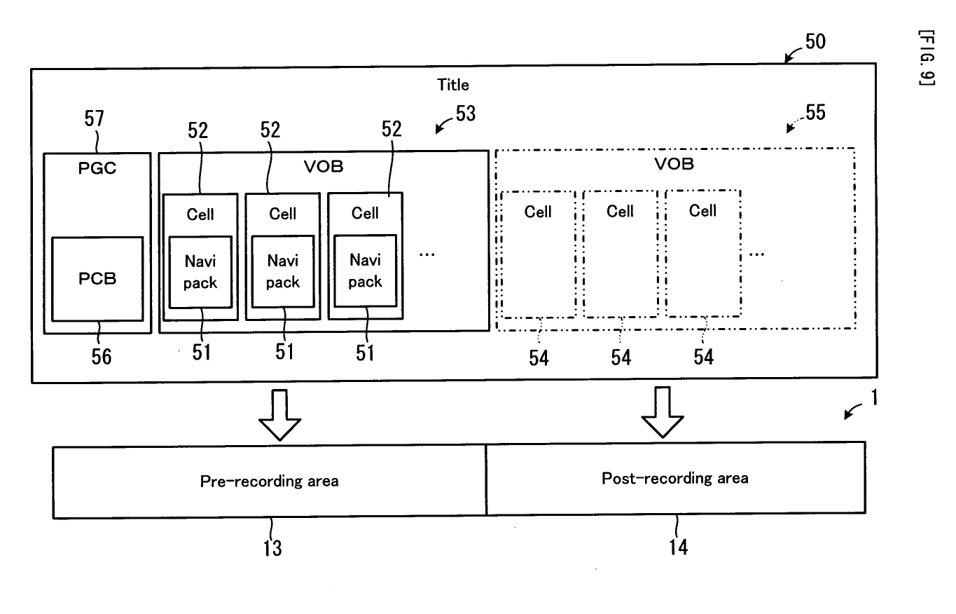

FIG. 6 shows a state in which reproduction data unit is recorded in the unit area. As a general rule, one reproduction data unit is recorded into one unit area 24. As shown in FIG. 8, however, it is also possible to record one reproduction data unit into two or more unit areas 24.

The reproduction data unit is recorded from the head of the unit area 24. Incidentally, if the length of one reproduction data unit is shorter than the length L1 of one unit area 24, there is a residual in a tail area of the unit area 24 after the reproduction data unit is recorded into the unit area 24. In this case, it is desirable to record dummy data (e.g. 0 data) into the residual area.

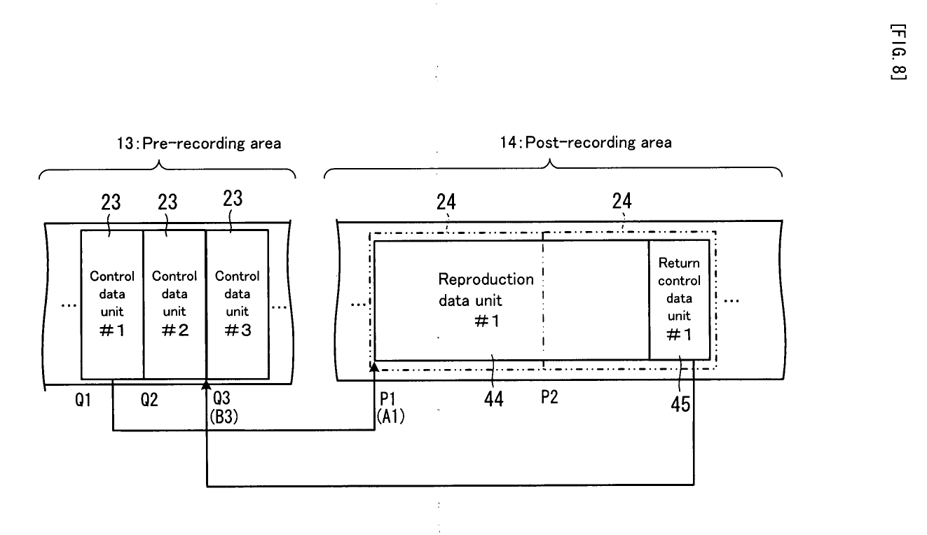

Moreover, as shown in FIG. 7 or FIG. 8, it is possible to record a back control data unit 43 or 45 into the unit area 24 with the reproduction data unit. In this case, the back control data unit 43 or 45 is recorded immediately after the reproduction data unit. As described above, the reproduction data unit is recorded by the consumer public who purchases the recording disc 1 with a recording apparatus or the like. In the same manner, the back control data unit 43 or 45 can be recorded by the consumer public with the recording apparatus or the like.

The back control data unit includes return position information (e.g. an address number) which indicates the recording position of the control data unit 23 corresponding to the unit area 24 next to the unit area 24 in which the back control data unit is recorded, or its immediately preceding position.

Incidentally, if the back control data unit is recorded into the unit area 24, the length information 32 may be eliminated from the control data unit 23 recorded in the pre-recording area 13.

### (Reproduction Operation 1)

The reproduction of the reproduction data unit recorded in the unit area 24 has three procedures shown in FIG. 6, FIG. 7, and FIG. 8.

Firstly, with reference to FIG. 6, the first reproduction procedure will be explained. The reproducing apparatus firstly disposes the irradiation position of a light beam irradiated from an optical pickup, to the recording position of the general control data 22 in the pre-recording area 13, to thereby read the general control data 22 (refer to FIG. 2).

Then, the reproducing apparatus refers to the order information 33 included in the general control data 22 (refer to FIG. 4). The order information 33 indicates the reading order of the control data unit 23, for example. It is assumed that the reading order of the control data unit 23 is #1, #2, #3 and so on in FIG. 6, according to the order information 33. The reproducing apparatus recognizes the reading order of the control data unit 23 on the basis of the order information 33, and it reads the control data units #1, #2, #3 and so on in accordance with the reading order.

That is, the reproducing apparatus firstly disposes the irradiation position of the light beam to a recording position Q1 of the control data unit #1 in the pre-recording area 13, and it reads the control data unit #1.

In the unit area 24 corresponding to the control data unit #1, a reproduction data unit #1 (41) is recorded. Then, the control data unit #1 includes the position information 31 (refer to FIG. 3), and the position information 31 is specifically a head address number A1 of the unit area 24 in which the reproduction data unit #1 is recorded. Moreover, the control data unit #1 includes the length information 32 which indicates the length L1 of the unit area 24 in which the reproduction data unit #1 is recorded (refer to FIG. 3). The reproducing apparatus refers to the position information 31 and the length information 32 included in the control data unit #1 and recognizes the address number A1 and the length L1.

Then, the reproducing apparatus jumps the irradiation position of the light beam to a position P1 corresponding to the address number A1 in the post-recording area 14. Then, the reproducing apparatus reads the reproduction data unit #1 and reproduces it.

Then, the reproducing apparatus recognizes a reading end position of the reproduction data unit #1 on the basis of the address number A1 and the length L1.

If ending the reading of the reproduction data unit #1, the reproducing apparatus jumps the irradiation position of the light beam to a recording position Q2 of the control data unit #2 in the pre-recording area 13. Then, the reproducing apparatus reads the control data unit #2.

The position information 31 included in the control data unit #2 is a specifically a head address number A2 of the unit area 24 in which a reproduction data unit #2 is recorded. Moreover, the control data unit #2 includes the length information 32 which indicates the length L1 of the unit area 24 in which the reproduction data unit #2 is recorded. The reproducing apparatus refers to the position information 31 and the length information 32 included in the control data unit #2 and recognizes the address number A2 and the length L1.

Then, the reproducing apparatus jumps the irradiation position of the light beam to a position P2 corresponding to the address number A2 in the post-recording area 14. Then, the reproducing apparatus reads the reproduction data unit #2 and reproduces it.

Then, the reproducing apparatus recognizes a reading end position of the reproduction data unit #2 on the basis of the address number A2 and the length L1.

If ending the reading of the reproduction data unit #2, the reproducing apparatus jumps the irradiation position of the light beam to a recording position Q3 of the control data unit #3 in the pre-recording area 13. Then, the reproducing apparatus reads the control data unit #3 and reproduces it.

The reproduction data unit recorded in the post-recording area 14 of the recording disc 1 is reproduced in the above procedure.

Incidentally, if the reproduction data unit is motion picture data, it is possible to make the following procedure: jumping from the control data unit #1 to the reproduction data unit #1, automatically going back to the original control data unit #1 after the reproduction of the reproduction data unit #1 is ended, and then transiting to the reading of the control data unit #2. In this case, the length information 32 can be eliminated.

### (Reproduction Operation 2)

Next, with reference to FIG. 7, the second reproduction procedure will be explained. The reproducing apparatus firstly disposes the irradiation position of the light beam, to the recording position of the general control data 22 in the pre-recording area 13, to thereby read the general control data 22.

Then, the reproducing apparatus refers to the order information 33 included in the general control data 22. It is assumed that the reading order of the control data unit 23 is #1, #2, #3 and so on in FIG. 7, according to the order information 33. The reproducing apparatus recognizes the reading order of the control data unit 23 on the basis of the order information 33, and reads the control data units #1, #2, #3 and so on in accordance with the reading order.

That is, the reproducing apparatus firstly disposes the irradiation position of the light beam to a recording position Q1 of the control data unit #1 in the pre-recording area 13, and it reads the control data unit #1.

In the unit area 24 corresponding to the control data unit #1, a reproduction data unit #1 (42) and a back control data unit #1 (43) are recorded. On the other hand, the position information 31 included in the control data unit #1 is specifically a head address number A1 of the unit area 24 in which the reproduction data unit #1 is recorded. The reproducing apparatus refers to the position information 31 included in the control data unit #1 and recognizes the address number A1.

Then, the reproducing apparatus jumps the irradiation position of the light beam to a position P1 corresponding to the address number A1 in the post-recording area 14. Then, the reproducing apparatus reads the reproduction data unit #1 and reproduces it.

If ending the reading of the reproduction data unit #1, the reproducing apparatus reads the back control data unit #1. The back control data unit #1 includes the return position information, and the return position information is specifically an address number B2 of the control data unit #2 corresponding to the unit area 24 next to the unit area 24 in which the back control data unit #1 is recorded. The reproducing apparatus refers to the return position information included in the back control data unit #1 and recognizes the address number B2.

Then, the reproducing apparatus jumps the irradiation position of the light beam to a position Q2 corresponding to the address number B2 in the pre-recording area 13. Then, the reproducing apparatus reads the control data unit #2.

In the unit area 24 corresponding to the control data unit #2, a reproduction data unit #2 and a back control data unit #2 are recorded. On the other hand, the position information 31 included in the control data unit #2 is specifically a head address number A2 of the unit area 24 in which the reproduction data unit #2 is recorded. The reproducing apparatus refers to the position information 31 included in the control data unit #2 and recognizes the address number A2.

Then, the reproducing apparatus jumps the irradiation position of the light beam to a position P2 corresponding to the address number A2 in the post-recording area 14. Then, the reproducing apparatus reads the reproduction data unit #2 and reproduces it.

If ending the reading of the reproduction data unit #2, the reproducing apparatus reads the back control data unit #2. The back control data unit #2 includes the return position information, and the return position information is specifically an address number B3 of the control data unit #3 corresponding to the unit area 24 next to the unit area 24 in which the back control data unit #2 is recorded. The reproducing apparatus refers to the return position information included in the back control data unit #2 and recognizes the address number B3.

Then, the reproducing apparatus jumps the irradiation position of the light beam to a position Q3 corresponding to the address number B3 in the pre-recording area 13. Then, the reproducing apparatus reads the control data unit #3.

The reproduction data unit recorded in the post-recording area 14 of the recording disc 1 is reproduced in the above procedure.

### (Reproduction Operation 3)

Next, with reference to FIG. 8, the third reproduction procedure will be explained. The reproducing apparatus firstly disposes the irradiation position of the light beam, to the recording position of the general control data 22 in the pre-recording area 13, to thereby read the general control data 22.

Then, the reproducing apparatus refers to the order information 33 included in the general control data 22. It is assumed that the reading order of the control data unit 23 is #1, #2, #3 and so on in FIG. 8, according to the order information 33. The reproducing apparatus recognizes the reading order of the control data unit 23 on the basis of the order information 33, and it reads the control data units #1, #2, #3 and so on in accordance with the reading order.

The reproducing apparatus firstly disposes the irradiation position of the light beam to a recording position Q1 of the control data unit #1 in the pre-recording area 13, and it reads the control data unit #1.

In the unit area 24 corresponding to the control data unit #1, the former part of a reproduction data unit #1 (44) is recorded. On the other hand, the position information 31 included in the control data unit #1 is specifically a head address number A1 of the unit area 24 in which the former part of the reproduction data unit #1 is recorded. The reproducing apparatus refers to the position information 31 included in the control data unit #1 and recognizes the address number A1.

Then, the reproducing apparatus jumps the irradiation position of the light beam to a position P1 corresponding to the address number A1 in the post-recording area 14. Then, the reproducing apparatus starts to read the former part of the reproduction data unit #1.

In the unit area 24 next to the unit area 24 in which the former part of the reproduction data unit #1 is recorded, the latter part of the reproduction data unit #1 is recorded. That is, since the reproduction data unit in FIG. 8 is longer than one unit area 24, it is recorded over two unit areas 24. The reproducing apparatus reads the former part of the reproduction data unit #1 and then continuously reads the latter part of the reproduction data unit #1. Then, the reproducing apparatus reproduces the former part and the latter part of the reproduction data unit #1.

If ending the reading of the latter part of the reproduction data unit 1, the reproducing apparatus reads the former part of a back control data unit #1. The back control data unit #1 includes the return position information, and the return position information is specifically an address number B3 of the control data unit #3 corresponding to the unit area 24 next to the unit area in which the back control data unit #1 is recorded. The reproducing apparatus refers to the return position information included in the back control data unit 31 and recognizes the address number B3.

Then, the reproducing apparatus jumps the irradiation position of the light beam to a position Q3 corresponding to the address number B3 in the pre-recording area 13. Then, the reproducing apparatus reads the control data unit #3.

The reproduction data unit recorded over two or more unit areas 24 is reproduced in the above procedure. In conclusion, if the reproduction data unit is recorded over two or more unit areas 24, the reproducing apparatus firstly recognizes the recording position of the head of the reproduction data unit on the basis of the position information of the control data unit corresponding to the unit area 24 in which the head of the reproduction data unit is recorded, and then accesses its recording position. Then, when starting to read the reproduction data unit, the reproducing apparatus continuously reads and reproduces the reproduction data unit until completing the reading of the tail of the reproduction data unit. Then, if completing the reading of the tail of the reproduction data unit, the reproducing apparatus reads the back control data unit, which is recorded following the reproduction data unit, and it returns the irradiation position of the light beam to the pre-recording area 13 in accordance with the return position information included in the back control data unit.

The return position information included in the back control data unit indicates the recording position of the control data unit corresponding to the unit area 24 next to the unit area 24 in which the back control data unit is recorded. Therefore, the reproducing apparatus reads the back control data unit before it reads the control data unit 23 corresponding to the unit area 24 next to the unit area 24 in which the back control data unit is recorded. As a result, it sometimes skips several control data units 23. That is, if there are m unit areas 24 (m is an integer of 1 or more) between the unit area 24 in which the head of one reproduction data unit is recorded and the unit area 24 in which the tail of the reproduction data unit is recorded, the m control data units 23 corresponding to the m unit areas are skipped. This is because the control data unit 23 and the unit area 24 have the one-to-one correspondence relationship and this correspondence relationship is determined in advance by the reproduction order control data 21 which cannot be rewritten.

### (Integrity of Control Data Unit and Reproduction Data Unit)

Now, the integrity of the control data unit 23 and the reproduction data unit is explained. The control data unit 23 recorded in advance in the pre-recording area 13 and the reproduction data unit post-recorded into the unit area 24 of the post-recording area 14 have the integrity, and the both data units constitute one content data group.

That is, as a general rule, the head position and the length of the unit area 24 are determined in advance by the position information and the length information included in the control data unit 23. Then, a position to start the recording of the reproduction data unit is the head position of the unit area 24 as a general rule. Therefore, if the reproduction data unit is recorded into the unit area 24, the recording position of the reproduction data unit is immediately determined, and the recording position is clearly indicated by the position information.

Moreover, the access order of the unit area 24 is determined in advance by the control data unit and the order information. Therefore, if it is determined which of the plurality of reproduction data units is recorded into which unit area 24 and if the plurality of reproduction data units are recorded into the plurality of unit areas 24 in accordance with the determination, that alone determines the reproduction order of the reproduction data unit.

Such one content data group can be realized by one title 50 based on the DVD video standard, for example, as shown in FIG. 9. That is, a VOB (Video Object) 53 is formed of a plurality of cells 52 including only navigation packs 51. Moreover, a virtual VOB 55 is formed of a plurality of cells 54 which have no content. Then, the information which indicates the length of each cell and the head address number of each cell 54 which constitutes the VOB 55 is added to the navigation pack 51 included in the VOB 53. At this time, the head address number is determined such that the head address number of each cell 54, which constitutes the VOB 55, indicates the position in the post-recording area 14 of the recording disc 1 when the VOB 53 is recorded into the pre-recording area 13 of the recording disc 1. Moreover, a PCB 56 for defining the reproduction order of the cells 52 which constitute the VOB 53 is prepared, and this is included into a PGC (ProGram Chain) 57. Lastly, the PGC 57 and the VOB 53 are recorded into the pre-recording area 13 of the recording disc 1 as embossed pits.

Incidentally, such an integrity structure of the control data unit and the reproduction data unit is not limited to the title based on the DVD video standard. Such an integrity structure can be realized by one data group according to a standard which obliges that first data into which target content for directly reproducing is coded and second data for determining the reproduction order of the first data are arranged in the one data group.

### (Recording Medium Identification Information)

Recording medium identification information is recorded in advance on the recording disc 1. That is, in the recording disc 1, as shown in FIG. 1, the pre-recording area 13 and the post-recording area 14 are formed on the recording layer, and the reproduction order control data 21 is recorded in advance in the pre-recording area 13 and the post-recording area 14 is unrecorded in the shipping from a factory. On the recording disc 1, the recording medium identification information, which is to indicate that the recording disc 1 is a recording disc having such a unique structure, is recorded in advance in the shipping from a factory. By this, the recording medium identification information is read by the reproducing apparatus before the reproduction order control data 21 recorded on the recording disc 1 is read by the reproducing apparatus. By this, it is possible to make the reproducing apparatus recognize that the recording disc 1 is the recording disc having such a unique structure described above.

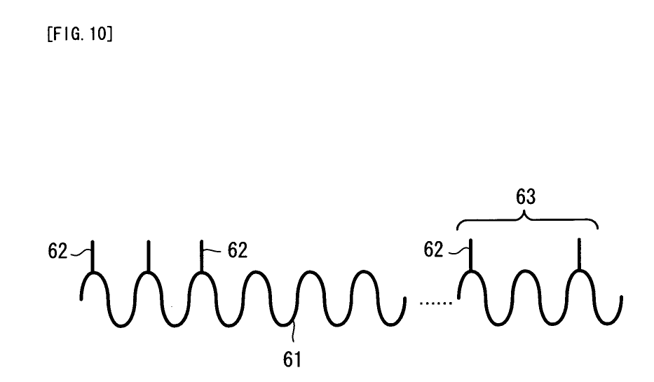

Specifically, the recording medium identification information is desirably recorded as a flag in a disc manufacturing information area in the lead-in area 11 of the recording disc 1. Moreover, if the recording layer formed in the pre-recording area of the recording disc is the recording layer of a DVD-R or a DVD-RW, as shown in FIG. 10, the recording medium identification information may be recorded in a reserve area 63 of land pre-pit data which is provided with land pre-pits 62 formed between each wobble track 61.

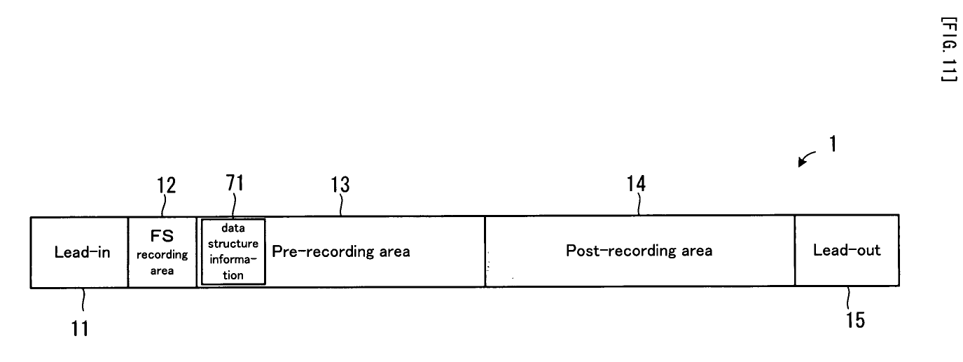

Moreover, as shown in FIG. 11, data structure information 71 including the recording content of the pre-recording area 13, the address information of the post-recording area 14, the length of the unit area 24, and the like may be recorded in advance in the head area of the pre-recording area 13. By this, the data structure information 71 is read by the reproducing apparatus before the reproduction order control data 21 recorded on the recording disc 1 is read by the reproducing apparatus. By this, it is possible to make the reproducing apparatus recognize the recording content of the pre-recording area 13, the address information of the post-recording area 14, the length of the unit area 24, and the like.

### (Various Structures of Reproduction Data Unit)

As described above, the reproduction data unit may be one still image data, a combination of a plurality of still image data, motion picture data, or mixed data of the motion picture data and the audio data.

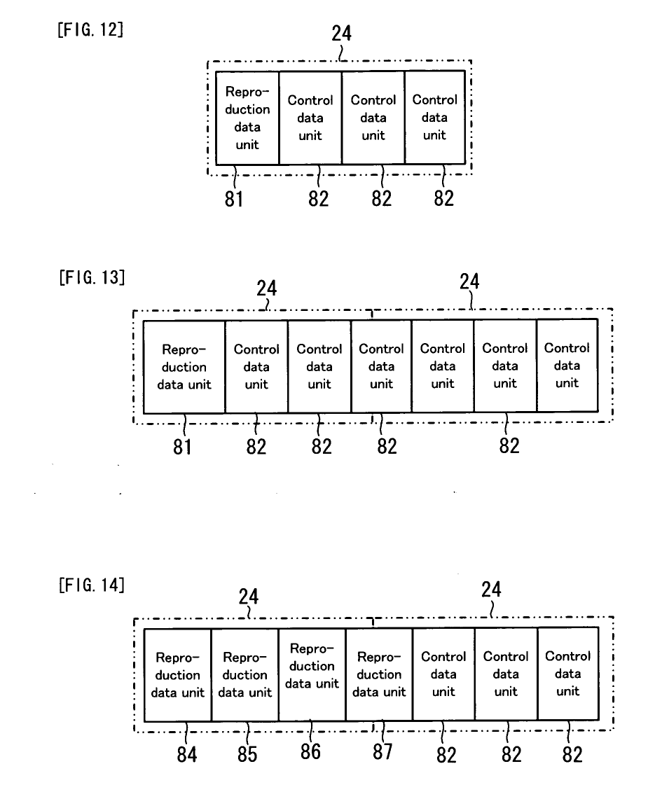

For example, as shown in FIG. 12, a reproduction data unit 81 which is formed of one still image data is recorded into one unit area 24, and immediately after that, three control data units 82 including information which indicates the unit display duration of a still image are recorded. For example, if the unit display duration is one second, the still image corresponding to the still image data can be continuously displayed for three seconds by the reproducing apparatus. Moreover, as shown in FIG. 13, a reproduction data unit 81 which is formed of one still image data is recorded into two continuous unit areas 24, and immediately after that, six control data units 82 including information which indicates the unit display duration of the still image are recorded. For example, if the unit display duration is one second, the still image corresponding to the still image data can be continuously displayed for six seconds by the reproducing apparatus. As described above, by recording the control data units 82 including the information, which indicates the unit display duration of the still image, immediately after the reproduction data unit 81, which is formed of one still image data, it is possible to set the unit display duration of the still image corresponding to the still image data, and it is possible to easily change the unit display duration of the still image only by determining the number of the control data units 82 to be recorded. This allows easy setting of a slide speed to slide pictures in a slide show, for example.

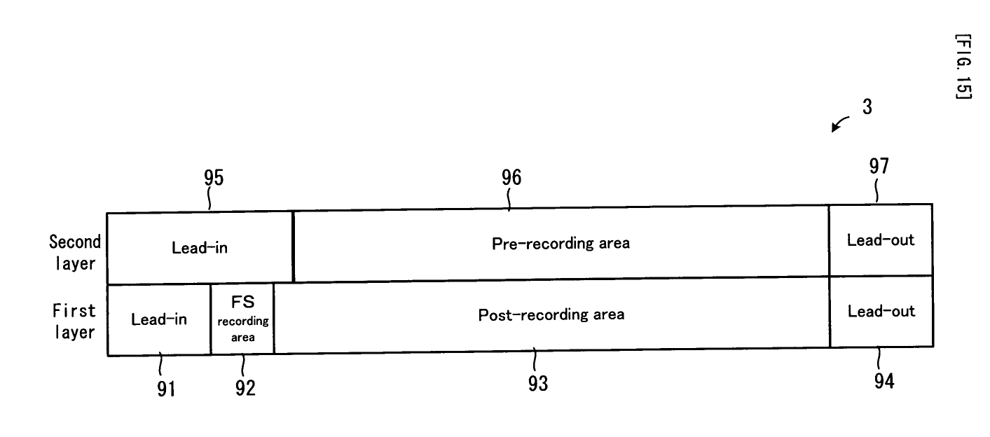

Moreover, as shown in FIG. 14, four reproduction data units 84, 85, 96, and 87, which are formed of the still image data of the gradually changing still image, are arranged in the unit areas 24, and immediately after that, three control data units 82 including information which indicates the unit display duration of the still image are arranged. By this, it is possible to create a transition effect by using the reproduction data unit 84 or 87, and it is possible to continuously display the still image after the transition effect is finished (or the still image data by the reproduction data unit 87) for a while.

As explained above, on the recording disc 1, (a) there is the recordable or rewritable post-recording area 14, (b) the post-recording area 14 is divided in advance into the plurality of unit areas 24, (c) the reproduction order control data 21 includes in advance the position information which indicates the position of each unit area 24, and (d) the reproduction order control data 21 includes in advance the information or order which indicates the reproduction order of each unit area 24. By this, it is possible to form one content data group in which the reproduction order control data 21 and the reproduction data unit are unified or integrated, only by post-recording the reproduction data unit into the unit area 24.

That is, the position information which indicates the position of each unit area 24 exists in advance, the position of each unit area 24 is determined in advance by the position information, and the reproduction data unit is recorded into the unit area 24. Therefore, if the reproduction data unit is recorded into the unit area 24, the recording position of the reproduction data unit is immediately determined, and the recording position is clearly indicated by the position information.

Moreover, the access order of the unit area 24 is determined in advance by the reproduction order control data. Therefore, if it is determined which of the plurality of reproduction data units is recorded into which unit area 24 and if the plurality of reproduction data units are recorded into the plurality of unit areas 24 in accordance with the determination, that alone determines the reproduction order of the reproduction data unit.

As described above, according to the recording disc 1, it is possible to immediately determine the recording position and the reproduction order of the reproduction data unit only by simply recording the reproduction data unit into the unit area 24. Then, it is possible to form one content data group in which the reproduction order control data and the reproduction data unit are unified, by determining the recording position and the reproduction order of the reproduction data unit.

Therefore, according to the recording disc 1, it is unnecessary to perform authoring including the specification of the recording position of the reproduction data unit, the generation of the position information, the setting of the reproduction order, or the like, after the reproduction data unit is recorded. Thus, it is possible to eliminate the trouble of authoring in the process of producing a multimedia work, such as a DVD photo album. This can simplify the self-production of a multimedia work by the consumer public and the production of a multimedia work by a producing agent service company, and this can reduce a period for producing the multimedia work, or the like.

Moreover, according to the recording disc 1, the reproduction order control data 21 includes the control data unit 23 and the control data unit 23 and the unit area 24 correspond to each other one-to-one. Thus, it is possible to realize the formation of one content data group in which the reproduction order control data and the reproduction data unit are unified, more easily and efficiently.

Moreover, according to the recording disc 1, the length L1 of each unit area 24 is uniformed. Thus, it is possible to realize the formation of one content data group in which the reproduction order control data and the reproduction data unit are unified, more easily and efficiently.

Moreover, according to the recording disc 1, the post-recording area 14 for recording the reproduction data unit is set as the physically continuous area on the recording layer of the recording disc 1. Thus, it is possible to record even the reproduction data unit whose data length is long to some extent, such as motion picture data, into the post-recording area 14. Moreover, according to the recording disc 1, the plurality of unit areas 24 are continuously arranged in the post-recording area 14 which is physically continuous. Thus, it is possible to record the reproduction data units with various lengths at an excellent recording efficiency by changing the number of the unit areas 24 used for the recording of the reproduction data units. By this, it is possible to produce a multimedia work by using the various reproduction data units whose lengths, qualities, types, and the like are different.

Moreover, according to the recording disc 1, the reproduction data unit and the return position information are recorded into the unit area 24, and the return position information indicates the recording position of the control data unit 23 corresponding to the unit area 24 next to the unit area 24 in which the return position information is recorded, or its immediately preceding position. Thus, it is possible to easily make a control flow from the reading of the reproduction data unit to the reading of the following control data unit.

Moreover, according to the return position information, by recording the return position information following the tail of the reproduction data unit, it is possible to make a control flow from the reading of the reproduction data unit to the reading of the following control data unit even if the recording position of the tail of the reproduction data unit is changed depending on the length of the reproduction data unit. Therefore, it is possible to record the reproduction data units with various lengths. By this, it is possible to produce a multimedia work by using the various reproduction data units whose lengths, qualities, types, and the like are different.

Moreover, according to the recording disc 1, it is prevented that the reproduction order control data is rewritten by making non-rewritable reproduction order control data recorded in advance in the pre-recording area 13. By this, it is possible to prevent the data structure set in advance, such as the data structure in which the reproduction order control data corresponds to the unit area, from being damaged later. At the same time, by making the post-recording area 14 additionally recordable or rewritable, it is possible to allow the reproduction data unit to be post-recorded, and it is possible to improve the degree of freedom in producing a multimedia work by the consumer public.

### (Application to Dual-Layer Recording Disc)

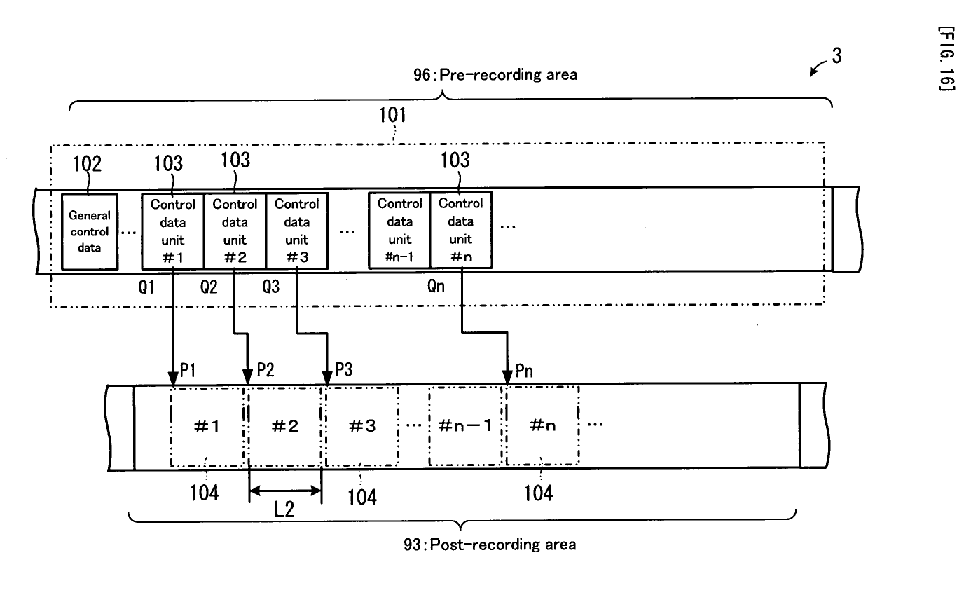

FIG. 15 shows a recording disc in a second embodiment of the information recording medium of the present invention.

A recording disc 3 in FIG. 15 has recording layers of a single-sided, dual layer type. Out of the recording layers of the recording disc 3, the recording layer in which the distance from an outer surface, irradiated with the light beam for data recording/reproduction, is relatively small is a first layer (layer 0), and the recording layer in which the distance from the outer surface, irradiated with the light beam for data recording/reproduction, is relatively large is a second layer (layer 1).

The recording disc 3 is a hybrid dual-layer recording disc provided with a read-only recording layer and a recordable (or write-once) recording layer. That is, the second layer of the recording disc 3 is the read-only recording layer, and the first layer is the recordable recording layer. For example, the recording disc 3 is a hybrid DVD provided with the second layer of a DVD-ROM (DVD-Read Only Memory) and the first recording layer of a DVD-R.

In the recording disc 3, the second layer is a physically read-only recording layer. In the second layer, embossed pits are formed in advance by using a stampa or the like. With respect to the second layer, the data can neither written once nor rewritten. On the other hand, the first layer is a physically recordable recording layer, and it is formed of an organic dye film, for example. With respect to the first layer, it is possible to record the data as pits by using heat deformation of the organic dye film or a change in refractive index of the organic dye film by heat. However, the once recorded data cannot be rewritten.

Incidentally, in the information recording medium of the present invention, the second layer can be the physically recordable recording layer, and the first layer can be the physically read-only recording layer. However, like the recording disc 3 shown in FIG. 15, by setting the second layer as the physically read-only recording layer and the first layer as the physically recordable layer, the recording disc 3 can be manufactured inexpensively by using exiting techniques or existing materials. That is, by setting the second layer as the read-only recording layer, the second layer can have almost the same structure as that of the second layer of a general single-sided, dual layer DVD-ROM. By this, the second layer of the recording disc 3 can be manufactured inexpensively by using exiting techniques or existing materials used for the single-sided, dual layer DVD-ROM. Moreover, by setting the first layer as the recordable recording layer, the first layer can have almost the same structure as that of the first layer of a general single layer DVD-R. By this, the first layer of the recording disc 3 can be manufactured inexpensively by using exiting techniques or existing materials used for the single layer DVD-R. Specifically, the first layer of the recording disc 3 can be manufactured only by changing the reflective film of the recording layer of the single layer DVD-R to a semi-transmissive film.

However, the information recording medium of the present invention may be an information recording medium provided substantially with an area in which the read-only data is recorded in advance and an area in which the data can be written once or rewritten. Therefore, in the dual-layer recording disc to which the present invention is applied, the second layer may be set as the physically recordable recording layer or the physically rewritable recording layer, and the data recorded in advance in this recording layer may not be able to be rewritten by an information processing method. Moreover, the first layer may be set as the rewritable recording layer formed of a phase change film.

The recording disc 3 employs a method of promoting the recording and reading from the inner circumferential side to the outer circumferential side of the disc substrate, i.e. a parallel track path method.

As shown in FIG. 15, in the first layer of the recording disc 3, there are formed a lead-in area 91, a file system recording area 92, a pre-recording area 93, and a post-recording area 94, from the inner circumferential side to the outer circumferential side. Moreover, in the second layer of the recording disc 3, there are formed a lead-in area 95, a pre-recording area 96, and a lead-out area 97, from the inner circumferential side to the outer circumferential side.

The file system recording area 92 is an area for recording a file system. In the shipping from a factory of the recording disc 1, the file system is not recorded in the file system recording area 92, and the file system recording area 92 is unrecorded. The file system is recorded after the recording of the reproduction data unit is completed.

In the pre-recording area 96, the reproduction order control data is recorded in advance. That is, in the pre-recording area 96, embossed pits corresponding to the reproduction order control data are formed in advance by using a stampa or the like.

The post-recording area 93 is an area for recording the reproduction data unit. The post-recording area 93 is desirably one physically continuous area on the first layer. In the post-recording area 93, the reproduction data unit can be written once. In the shipping from a factory of the recording disc 3, the reproduction data unit is not recorded in the post-recording area 93, and the post-recording area 93 is unrecorded, for example. The reproduction data unit is recorded by the consumer public who purchases the recording disc 3 with a recording apparatus or the like.

FIG. 16 shows the reproduction order control data recorded in the pre-recording area 96 of the recording disc 3 and unit areas in the post-recording area 93. As shown in FIG. 16, the post-recording area 93 is partitioned into a plurality of unit areas 104. In the unit area 104, as in the case of the recording disc 1 described above, the reproduction data unit is recorded. Each unit area 104 has a predetermined length L2, and the unit areas 104 are physically continuously arranged. The lengths L2 of the unit areas 104 are desirably all constant and equal. The length L2 of each unit area 104 is desirably greater than the length of one ECC block. Moreover, the length L2 of each unit area 104 is more desirably long enough to record about one I picture based on a MPEG standard.

On the other hand, reproduction order control data 101 recorded in advance in the pre-recording area 96 is data for controlling the reproduction order of the reproduction data unit recorded in each unit area 104. The reproduction order control data 101 includes general control data 102 and a plurality of control data units 103. The control data unit 103 and the unit area 104 correspond to each other. The control data unit 103 includes the position information and the length information. The position information indicates the position of the unit area 104 corresponding to the control data unit 103. For example, a control data unit #1 includes an address head number P1 of a unit area #1. A control data unit #2 includes an address head number P2 of a unit area #2. A control data unit #n includes an address head number Pn of a unit area #n. The length information indicates the length L2 of the unit area 104 corresponding to the control data unit 103.

The general control data 102 includes the order information. The order information describes the reading order of the control data unit 103, for example.

Moreover, the first unit area 104 (#1) is disposed on the inner circumferential side of the first layer. Then, the second unit area 104 (#2) is adjacent to the outer circumferential side of the first unit area 104, and afterward, the third unit area 104, the fourth and so on are continuously arranged toward the outer circumferential side of the first layer. In the same manner, the first control data unit 103 (#1) is disposed on the inner circumferential side of the second layer. Then, the second control data unit 103 (#2) is adjacent to the outer circumferential side of the first control data unit 103, and afterward, the third control data unit 103, the fourth and so on are continuously arranged toward the outer circumferential side of the second layer. Because of such arrangement, the unit area 104 and the control data unit 103, which correspond to each other, are disposed over the recording layers, yet they are closer to each other. According to circumstances, the unit area 104 and the control data unit 103, which correspond to each other, sometimes overlap each other, as observed in a perpendicular direction to the disc surface of the recording disc 3. In this case, the unit area 104 and the control data unit 103, which correspond to each other, come extremely closer in position. That is, as shown in FIG. 16, in some cases, the unit area #1 corresponding to the control data unit #1 is located immediately under the control data unit #1, and the control data unit #1 and the unit area #1 come extremely close. By this, when the reproduction data unit recorded in the unit area 104 is reproduced, it is possible to reduce a seek time of an optical pickup. That is, when the reproduction data unit is reproduced, the irradiation position of the light beam is frequently reciprocated between the position of the unit area 104 and the recording position of the control data unit 103, which correspond to each other. According to the recording disc 3, the distance is small between the position of the unit area 104 and the recording position of the control data unit 103, which correspond to each other. Thus, the travel distance of the irradiation position of the light beam, i.e. the distance of the jump, becomes small. As a result, the seek time of the optical pickup is reduced.

Moreover, the reproduction order of the reproduction data unit recorded in the unit area 104 is substantially the same as that in the recording disc 1 described above, except that the irradiation position of the light beam is reciprocated over the layers. In the case of the recording disc 3, however, the reproduction order control data 101 is recorded in the second layer. Thus, immediately after the recording disc 3 is inserted into the reproducing apparatus and the reproduction process is started by the reproducing apparatus, it is necessary to dispose the irradiation position of the light beam to the recording position of the head of the reproduction order control data 101 in the second layer. Thus, it is necessary to describe the order or position information to realize such displacement into the file system or the like, for example.

Incidentally, one portion of the reproduction order control data or menu information or the like may be recorded immediately after the file system recording area 92 in the first layer. In this case, if one portion of the reproduction order control data or menu information or the like includes the order or position information to dispose the irradiation position of the light beam from the first layer to the second layer, it is possible to smoothly promote the data reading at the start of the reproduction process.

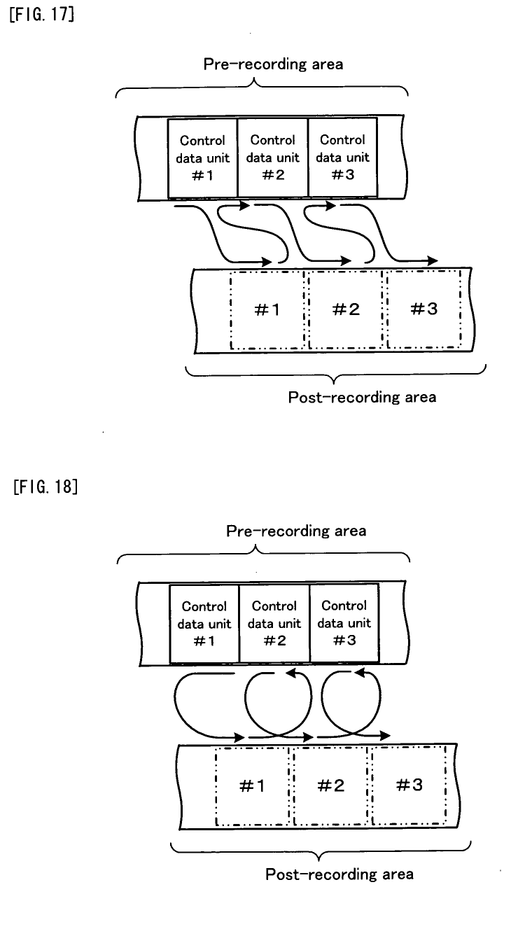

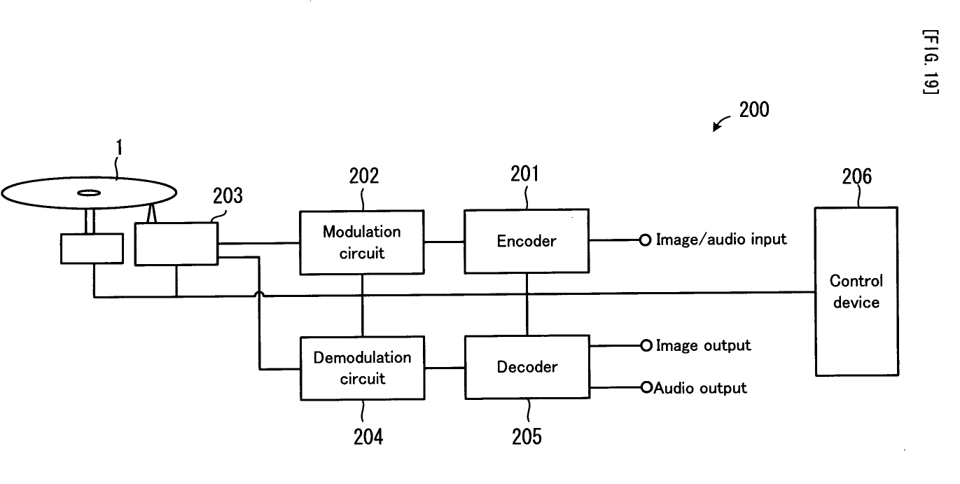

Moreover, the recording disc 3, as shown in FIG. 17, employs the parallel track path method in which the data reading direction in the first layer is equal to the data reading direction in the second layer. The present invention, however, is not limited to this, and as shown in FIG. 18, it can also employ an opposite track path method in which the data reading direction in the first layer is opposite to the data reading direction in the second layer.

As explained above, according to the recording disc 3, it is possible to immediately form one content data group in which the reproduction order control data 101 and the reproduction data unit are unified, only by recording the reproduction data unit into the unit area 104. By this, it is possible to eliminate the trouble of authoring in the process of producing a multimedia work, such as a DVD photo album. This can simplify the self-production of a multimedia work by the consumer public and the production of a multimedia work by a producing agent service company, and this can reduce a period for producing the multimedia work, or the like. In addition, according to the recording disc 3, it is possible to obtain almost the same operation effect as that of the recording disc 1.

### (Recording/Reproducing Apparatus)

FIG. 19 shows a recording/reproducing apparatus in an embodiment of the recording apparatus of the present invention. A recording/reproducing apparatus 200 in FIG. 19 has a function of recording and reproducing the reproduction data unit with respect to the aforementioned recording disc 1.

On the recording/reproducing apparatus 200, the reproduction data unit or the like is recorded basically as follows. That is, the recording/reproducing apparatus 200 encodes the still image data, the motion picture data, or the audio data or the like, which are inputted from the exterior, by using an encoder 201, to thereby generate the reproduction data unit or the like. Moreover, the recording/reproducing apparatus 200 modulates the generated reproduction data unit or the like by using a modulation circuit 202 and records it into the post-recording area 14 of the recording disc 1 by using an optical pickup 203.

On the other hand, the reproduction data unit or the like recorded on the recording disc 1 is reproduced as follows. That is, the recording/reproducing apparatus 200 reads the reproduction data unit or the like recorded on the recording disc 1 by using the optical pickup 203, demodulates it by using a demodulation circuit 204, and decodes it by using a decoder 205. Then, the recording/reproducing apparatus 200 displays a still image or motion picture corresponding to the still image data or motion picture data obtained in this manner, on a display apparatus or the like connected to the recording/reproducing apparatus 200, and it outputs the audio data to a speaker or the like connected to the recording/reproducing apparatus 200.

A control device 206 controls such a recording process and reproduction process. The control device 206 is formed of a central processing unit, a microprocessor, a microcomputer, or the like.

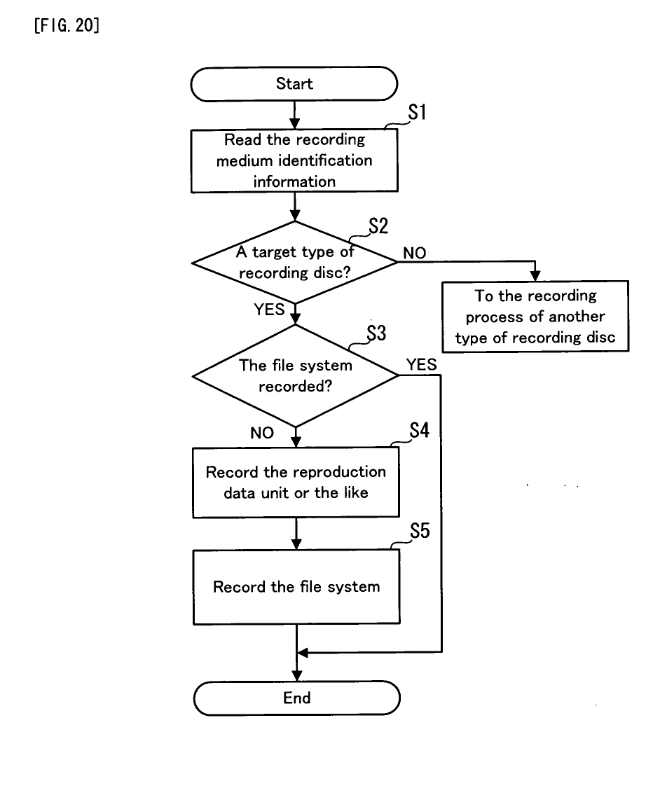

FIG. 20 shows the detailed content of the recording process of recording the reproduction data unit or the like on the recording/reproducing apparatus 200.

In FIG. 20, if the recording disc 1 is inserted into a disc slot of the recording/reproducing apparatus 200, the control device 206 reads the recording medium identification information recorded on the recording disc 1 (step S1). Then, the control device 206 judges whether the recording disc 1 is a target type of recording disc, i.e. whether or not the recording disc 1 is a recording disc on which the reproduction order control data 21 is recorded in advance in the pre-recording area 13 and the reproduction data unit can be written once into the post-recording area 14, on the basis of the recording medium identification information (step S2).

If the recording disc 1 is a target type of recording disc (the step S2: YES), then, the control device 206 judges whether or not the file system is recorded on the recording disc 1 (step S3).

If the file system is recorded on the recording disc 1 (the step S3: YES), then, the control device 206 records the reproduction data unit or the like onto the recording disc 1 (step S4).

When the recording of the reproduction data unit or the like is ended, the control device 206 records the file system into the file system recording area 12 of the recording disc 1 (step S5).

Incidentally, if the recording disc is not a desired type of recording disc but another type of recording disc in the step S2, the control device 206 moves to the recording process of the another type of recording disc.

Moreover, if the file system is already recorded on the recording disc 1 in the step S3, the control device 206 judges that the recording disc 1 has already completed the recording of the reproduction data unit and it is a disc on which the reproduction data unit is no longer newly written once, and it ends the recording process immediately.

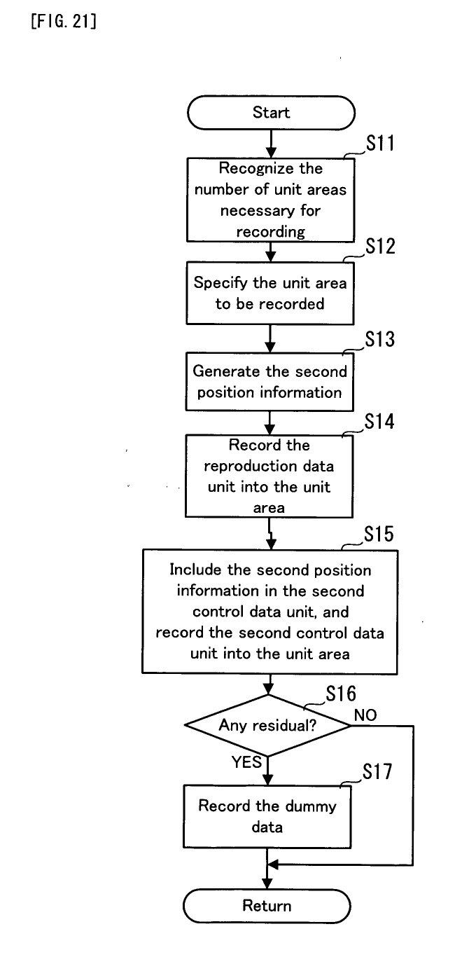

FIG. 21 shows the content of the recording process of recording the reproduction data unit or the like onto the recording disc 1 in more details, which is performed in the step S4 in FIG. 20.

In FIG. 21, when the reproduction data unit is recorded onto the recording disc 1, the control device 206 firstly recognizes the number of the unit areas 24 necessary to record the reproduction data unit (step S11). For example, the control device 206 calculates the total length of the length of the reproduction data unit and the length of the back control data unit, and divides the total length by the length of one unit area 24.

Then, the control device 206 specifies the unit area 24 into which the reproduction data unit is to be recorded (step S12). Normally, the reproduction data unit is continuously recorded in accordance with the arrangement order of the unit area 24, i.e. from the first unit area 24 disposed on the inner circumferential side of the recording disc 1 to the outer circumferential side of the recording disc 1. Therefore, if the recording state of the reproduction data unit in the post-recording area 14 is changed in order from the inner circumferential side of the recording disc 1, then it is possible to easily specify the unit area 24 into which the reproduction data unit is to be recorded.

Then, the control device 206 generates the return position information (step S13). That is, the control device 206 generates the position information which indicates the recording position of the control data unit corresponding to the unit area 24 next to the unit area 24 in which the tail of the reproduction data unit is recorded, or its immediately preceding position.

Then, the control device 206 records the reproduction data unit into the unit area 24 (step S14). If the reproduction data unit is longer than one unit area 24, the reproduction data unit is recorded into a continuous area which is formed of the unit areas 24 which are minimum necessary to record the entire reproduction data unit.

Then, the control device 206 generates the back control data unit, includes the return position information into the back control data unit, and records the back control data unit into the unit area 24 or the continuous area (step S15). The position at which the back control data unit is recorded in the unit area 24 or the continuous area is immediately after the reproduction data unit recorded in the step S14.

Then, the control device 206 judges whether or not there is a residual (e.g. an unrecorded area) in the unit area 24 or the continuous area in which the reproduction data unit and the back control data unit are recorded in the immediately preceding step S14 and step S15 (step S16).

If there is a residual in the unit area 24 or the continuous area (the step S16: YES), the control device 206 records dummy data into the residual area in the unit area 24 or the continuous area to fill the residual area with the dummy data (step S17).

If there are a plurality of reproduction data units to be recorded on the recording disc 1, the process in FIG. 21 is repeated a plurality of times.

As explained above, according to the recording/reproducing apparatus 200, it is possible to immediately form one content data group in which the reproduction order control data 21 and the reproduction data unit are unified, only by recording the reproduction data unit into the unit area 104. By this, it is possible to eliminate the trouble of authoring in the process of producing a multimedia work, such as a DVD photo album. This can simplify the self-production of a multimedia work by the consumer public and the production of a multimedia work by a producing agent service company, and this can reduce a period for producing the multimedia work, or the like.

Incidentally, the step S11 in FIG. 21 is a specific example of the recognizing device and the recognizing process, and the step S13 is a specific example of the position information generating device and the position information generating process. Moreover, the step S14 is a specific example of the first recording device and the first recording process, and the step S15 is a specific example of the second recording device and the second recording process.

Moreover, the embodiment of the recording apparatus described above may be realized by unifying it with hardware as an exclusive apparatus or by making a computer read a program. In this case, a computer program is prepared to realize the recognizing device, the position information generating device, the first recording device, and the second recording device.

Moreover, in the present invention, various changes may be made without departing from the essence or spirit of the invention which can be read from the claims and the entire specification. An information recording medium, a recording apparatus, a recording method, and a computer program, which involve such changes, are also intended to be within the technical scope of the present invention.

### INDUSTRIAL APPLICABILITY

The information recording medium, the recording apparatus, and the recording method according to the present invention can be applied to an information recording medium, such as a DVD, and they can be further applied to a recording apparatus, such as a DVD recorder. Moreover, they can be also applied to a recording apparatus or the like which can be mounted on or which can be connected to various computer equipment for commercial use or for business use.

1-21. (canceled)

22. An information recording medium comprising:
a pre-recording area in which reproduction order control data is recorded in advance; and
a post-recording area for recording a reproduction data unit,
wherein
the reproduction data unit can be additionally recorded into the post-recording area,
the post-recording area is partitioned into a plurality of unit areas, each of which has a predetermined length and which are physically continuously arranged, before the reproduction data unit is recorded into the post-recording area,
the reproduction order control data is data for controlling a reproduction order of the reproduction data unit recorded in each of the unit areas,
the reproduction order control data has position information, which indicates a position of each of the unit areas, before the reproduction data unit is recorded into the post-recording area,
the reproduction order control data includes a plurality of control data units, and each of the plurality of control data units corresponds to respective one of the plurality of unit areas, and
the reproduction data unit and return position information are recorded in the unit area, and the return position information indicates a recording position of the control data unit corresponding to the unit area next to the unit area in which the return position information is recorded, or its immediately preceding position.

23. The information recording medium according to claim 22, wherein the reproduction order control data has order information, which defines an order to access each of the unit areas, before the reproduction data unit is recorded into the post-recording area.

24. The information recording medium according to claim 22, wherein the reproduction order control data has a jump order, which orders to jump to each of the unit areas, before the reproduction data unit is recorded into the post-recording area.

25. The information recording medium according to claim 22, wherein the reproduction order control data has length information, which indicates a length of each of the unit areas, before the reproduction data unit is recorded into the post-recording area.

26. The information recording medium according to claim 22, wherein the post-recording area is one physically continuous area.

27. The information recording medium according to claim 22, wherein each of the unit areas has the same length.

28. The information recording medium according to claim 22, wherein the reproduction order control data is unrewritably recorded in the pre-recording area.

29. The information recording medium according to claim 22, wherein the post-recording area is unrecorded.

30. The information recording medium according to claim 22, wherein a file system is unrecorded.

31. The information recording medium according to claim 22, wherein recording medium identification information is recorded in advance, the recording medium identification information indicating an information recording medium on which the reproduction order control data is recorded in advance in the pre-recording area and on which the reproduction data unit can be additionally recorded into the post-recording area.

32. The information recording medium according to claim 22, wherein
the information recording medium has at least two recording layers, and
the pre-recording area is formed in one of the two recording layers, the post-recording area being formed in the other recording layer.

33. The information recording medium according to claim 32, wherein
the information recording medium has an outer surface which is irradiated with a light beam, and
a distance between the recording layer in which the pre-recording area is formed and the outer surface is greater than a distance between the recording layer in which the post-recording area is formed and the outer surface.

34. The information recording medium according to claim 32, wherein
the information recording medium has a disc-shaped substrate,
the two recording layers are laminated on the disc-shaped substrate, and
a direction of reading the reproduction order control data recorded in the pre-recording area is equal to a direction of reading the reproduction data unit recorded in the post-recording area, and the both reading directions are a predetermined radial direction of the disc-shaped substrate.

35. The information recording medium according to claim 22, wherein the reproduction order control data and the reproduction data unit form one content data group, and the content data group is one data group which complies with a standard which obliges that first data into which target content for directly reproducing is coded and second data for determining a reproduction order of the first data are arranged in the one data group.

36. The information recording medium according to claim 22, wherein the reproduction order control data and the reproduction data unit form one content data group, and the content data group is one data group which complies with a DVD video standard.

37. A recording apparatus for recording a reproduction data unit onto an information recording medium comprising: (a) a pre-recording area in which reproduction order control data is recorded in advance; and a post-recording area for recording a reproduction data unit, wherein (b) the reproduction data unit can be additionally recorded into the post-recording area, (c) the post-recording area is partitioned into a plurality of unit areas, each of which has a predetermined length and which are physically continuously arranged, (d) the reproduction order control data is data for controlling a reproduction order of the reproduction data unit recorded in each of the unit areas, (e) the reproduction order control data has a plurality of first control data units, (f) each of the plurality of first control data units corresponds to respective one of the plurality of unit areas, and (g) each of the plurality of first control data units has first position information, which indicates positions of the plurality of unit areas, or a jump order, which orders to jump to the plurality of unit areas, said recording apparatus comprising:
a recognizing device for recognizing the number of unit areas necessary to record the reproduction data unit and a second control data unit;
a position information generating device for generating second position information, which indicates a recording position of the first control data unit corresponding to the unit area next to a continuous area, which is formed of the number of unit areas recognized by said recognizing device, or its immediately preceding position;
a first recording device for recording the reproduction data unit into the continuous area; and
a second recording device for including the second position information into the second control data unit and recording the second control data unit, which includes the second position information, into the continuous area.

38. The recording apparatus according to claim 37, comprising a third recording device for recording dummy data into a residual area of the continuous area after recording the reproduction data unit and the second control data unit into the continuous area.

39. A recording method of recording a reproduction data unit onto an information recording medium comprising: (a) a pre-recording area in which reproduction order control data is recorded in advance; and a post-recording area for recording a reproduction data unit, wherein (b) the reproduction data unit can be additionally recorded into the post-recording area, (c) the post-recording area is partitioned into a plurality of unit areas, each of which has a predetermined length and which are physically continuously arranged, (d) the reproduction order control data is data for controlling a reproduction order of the reproduction data unit recorded in each of the unit areas, (e) the reproduction order control data has a plurality of first control data units, (f) each of the plurality of first control data units corresponds to respective one of the plurality of unit areas, and (g) each of the plurality of first control data units has first position information, which indicates positions of the plurality of unit areas, or a jump order, which orders to jump to the plurality of unit areas, said recording method comprising:
a recognizing process of recognizing the number of unit areas necessary to record the reproduction data unit and a second control data unit;
a position information generating process of generating second position information, which indicates a recording position of the first control data unit corresponding to the unit area next to a continuous area, which is formed of the number of unit areas recognized in said recognizing process, or its immediately preceding position;
a first recording process of recording the reproduction data unit into the continuous area; and
a second recording process of including the second position information into the second control data unit and recording the second control data unit, which includes the second position information, into the continuous area.

40. A computer program making a computer function as the recording apparatus according to claim 37.
